(19) United States
(12) Patent Application Publication
(10) Pub. No.: US 2012/0174036 A1
(43) Pub. Date: Jul. 5, 2012

(54) CONTENT REPRODUCTION DEVICE, CONTENT REPRODUCTION METHOD, PROGRAM, AND RECORDING MEDIUM

(76) Inventor: Hiroyuki MORIMOTO, Osaka (JP)

(21) Appl. No.: 13/412,803

(22) Filed: Mar. 6, 2012

Related U.S. Application Data
(63) Continuation of application No. PCT/JP2010/003520, filed on May 26, 2010.

(30) Foreign Application Priority Data
Dec. 14, 2009 (JP) 2009-282495

(51) Int. Cl. G06F 3/048

(52) U.S. Cl. 715/838

(57) ABSTRACT

A content reproduction device comprises: a display panel which displays a reproduction screen reproducing a content, a thumbnail of the content, and an icon about a genre to which the content belongs; a user input processing unit which receives a selection of the thumbnail or the icon; and a control unit which displays the thumbnail and the icon on the display panel simultaneously and displays a screen according to a result of the selection of the thumbnail or the icon received from the user input processing unit on the display panel.

### CROSS-REFERENCE TO RELATED APPLICATIONS

This application is a continuation application of PCT International Patent Application No. PCT/JP2010/003520 filed May 26, 2010, claiming the benefit of priority of Japanese Patent Application No. 2009-282495 filed Dec. 14, 2009, all of which are incorporated by reference herein in their entirety.

### FIELD OF THE INVENTION

The present invention relates to a content reproduction device and a content reproducing method which reproduces contents such as a photograph or a movie.

### RELATED ART OF THE INVENTION

In recent years, in portable mobile devices for carrying, etc, a device which is equipped with a GUI (Graphical User Interface) has spread, and a convenience for the user has improved.

A mobile device equipped with a GUI comprises a display panel on which a screen for reproducing a content is disposed. In the screen of the display panel, plural thumbnails corresponding to plural contents are displayed. These thumbnails are such as an input operation unit for starting an application about the content. Electronic equipment equipped with such GUI is described, for example, in Japanese Laid-Open Patent Publication No. 2005-4419 and Japanese Laid-Open Patent Publication No. 2008-140242.

Hereinafter, a conventional electronic device which is equipped with a GUI is described with reference to the drawings.

FIG. 17 is a front view illustrating the conventional electronic device displaying thumbnails and icons. In FIG. 17, plural thumbnails 1, 2 and an icon 3 are displayed on the screen of the electronic device. These thumbnails 1, 2 and the icon 3 are related mutually.

The icon 3 is a folder which stores data. Pictures showing content of data are displayed on the folder as the thumbnails 1, 2. When a user drags the thumbnail 2 with a mouse and moves the thumbnail 2 down the screen (reference to an arrow and a dotted line in figure), a folder corresponding to this thumbnail 2 is formed.

FIG. 18 is a front view illustrating a conventional electronic device in which thumbnail icons and direction change buttons are displayed. In FIG. 18, plural thumbnail icons 4 to 7 are displayed on the electronic device. On the thumbnail icon 5, direction change buttons 5A, 5B are displayed. The thumbnail icon 5 and the direction change buttons 5A, 5B are related mutually. When tapping the direction change buttons 5A, 5B with the pen 8, the user can rotate the direction of the picture of the thumbnail icon 5.

### DISCLOSURE OF THE INVENTION

### Problems to be Solved by the Invention

In mobile computing devices which are equipped with GUI, plural thumbnails corresponding to plural contents are simultaneously displayed on the screen, and one content corresponds to each thumbnail.

Generally, contents include various kinds such as a photograph, a movie, a music, etc, and media recording a content includes various kinds such as an optical disc, and a flash memory. Content recording devices which record a content include various kinds produced by hardware companies, etc. Applications for recording a content include various kinds produced by software companies, etc. Content makers include various makers.

However, in the above mentioned conventional electronic device reproducing contents, when a user selects and reproduces a desired content from various contents which are recorded on various media by such various applications or content recording devices, it is difficult to search for the desired content. That is, in the Japanese Laid-Open Patent Publication No. 2005-4419, Japanese Laid-Open Patent Publication No. 2008-140242, when searching for the desired content, it is necessary to scroll the screen or search from a file name. Therefore, in the conventional content reproduction device, if a file name is not known, or if a place where a content file exists is not known, it is difficult to search for the desired content.

In view of the above-mentioned problem of the conventional content reproduction, an object of the present invention is to provide a content reproduction device and a content reproduction method in which search performance improves greatly.

### Means for Solving the Problems

The 1^{st} aspect of the present invention is a content reproduction device, comprising:

a display panel which displays a reproduction screen reproducing a content, a thumbnail of the content, and an icon about a genre to which the content belongs;

a user input processing unit which receives a selection of the thumbnail or the icon; and

a control unit which displays the thumbnail and the icon on the display panel simultaneously and displays a screen according to a result of the selection of the thumbnail or the icon received from the user input processing unit, on the display panel.

The 2^{nd} aspect of the present invention is the content reproduction device according to the 1^{st} aspect of the present invention, wherein

the thumbnail and the icon are a touch-sensitive panel system, and compose the user input processing unit.

The 3^{rd} aspect of the present invention is the content reproduction device according to the 1^{st} aspect of the present invention, wherein

the control unit displays the icon about the genre to which the content of the thumbnail belongs in a domain where the thumbnail is displayed.

The 4^{th} aspect of the present invention is the content reproduction device according to the 3^{rd} aspect of the present invention, wherein

when plural genres to which the content belongs exist, the control unit displays plural icons corresponding to the plural genres.

The 5^{th} aspect of the present invention is the content reproduction device according to the 3^{rd} aspect of the present invention, wherein

the control unit displays plural thumbnails and plural icons on the display panel simultaneously and, in a domain where each thumbnail is displayed, displays the icon about the genre to which the content of the each thumbnail belongs.

The 6^{th} aspect of the present invention is the content reproduction device according to the 1^{st} aspect of the present invention, wherein

when receiving a selection of the thumbnail, the control unit starts an application which reproduces the content.

The 7^{th} aspect of the present invention is the content reproduction device according to the 1^{st} aspect of the present invention, wherein

when receiving a selection of the icon, the control unit displays a list of contents belonging to a genre to which the content belongs.

The 8^{th} aspect of the present invention is the content reproduction device according to the 7^{th} aspect of the present invention, wherein

the control unit displays the thumbnail which is simultaneously displayed with the icon, with the list of the contents.

The 9^{th} aspect of the present invention is the content reproduction device according to the 1^{st} aspect of the present invention, wherein

the thumbnail is a thumbnail of one content selected from plural contents belonging to the genre to which the content belongs, based on times of reproducing, date and time of reproducing, date and time of recording, or-date and time of making.

The 10^{th} aspect of the present invention is a content reproduction method, in which a content is reproduced, comprising:

a thumbnail-icon display step of displaying a thumbnail of a content and an icon about a genre of the content simultaneously; and

a screen display step of displaying a screen correspond to the thumbnail or the icon selected when the thumbnail or the icon is selected.

The 11^{th} aspect of the present invention is a program embodied on a non-transitory computer-readable medium, the program causing a computer to execute steps of a content reproduction method, the content reproduction method, in which a content is reproduced, comprising:

a thumbnail-icon display step of displaying a thumbnail of a content and an icon about a genre of the content simultaneously; and

a screen display step of displaying a screen correspond to the thumbnail or the icon selected when the thumbnail or the icon is selected.

### Advantage of the Invention

The present invention can provide a content reproduction device and a content reproduction method in which search performance improves greatly.

### BRIEF DESCRIPTION OF THE DRAWINGS

FIG. 1 is a front view illustrating a displaying state where a content reproduction device reproduces a content according to Embodiment 1 of the present invention;

FIG. 2 is a front view illustrating a state where a content reproduction device displays a content and a thumbnail according to Embodiment 1 of the present invention;

FIG. 3 is a view illustrating a database according to Embodiment 1 of the present invention;

FIG. 4 is a configuration view illustrating a content reproduction device according to Embodiment 1 of the present invention;

FIG. 5 is a view illustrating a movement of a content reproduction device according to Embodiment 1 of the present invention;

FIG. 6A is a front view illustrating a state where a list of a content of a content reproduction device is displayed according to Embodiment 1 of the present invention;

FIG. 6B is a front view illustrating a state where a list of a content of a content reproduction device is displayed according to Embodiment 1 of the present invention;

FIG. 6C is a front view illustrating a state where a list of a content of a content reproduction device is displayed according to Embodiment 1 of the present invention;

FIG. 6D is a front view illustrating a state where a list of a content of a content reproduction device is displayed according to Embodiment 1 of the present invention;

FIG. 7 is a front view illustrating a state at the time of a content selection of a content reproduction device according to Embodiment 1 of the present invention;

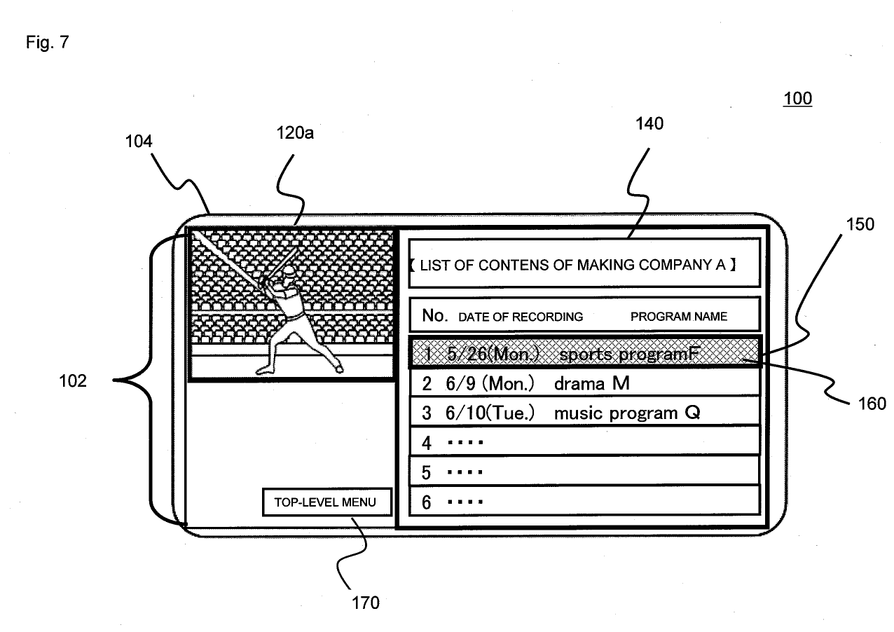

FIG. 8 is a front view illustrating a state at the time of a content reproduction of a content reproduction device according to Embodiment 1 of the present invention;

FIG. 9 is a front view illustrating a state at the time of a content selection of a content reproduction device according to Embodiment 1 of the present invention;

FIG. 10 is a front view where a content and a thumbnail of a content reproduction device are displayed according to Embodiment 1 of the present invention;

FIG. 11 is a front view where a list of contents of a content reproduction device is displayed according to Embodiment 1 of the present invention;

FIG. 12 is a front view where a list of contents of a content reproduction device is displayed according to Embodiment 1 of the present invention;

FIG. 13 is a front view illustrating a modified example of a content reproduction device according to Embodiment 1 of the present invention;

FIG. 14 is a front view illustrating a modified example of a content reproduction device according to Embodiment 1 of the present invention;

FIG. 15 is a front view illustrating a state where a list of contents of a modified example of a content reproduction device is displayed according to Embodiment 1 of the present invention;

FIG. 16 is a front view illustrating a state where a list of contents of a modified example of a content reproduction device is displayed according to Embodiment 1 of the present invention;

FIG. 17 is a front view illustrating a conventional electronic device in which icons and thumbnails are displayed; and

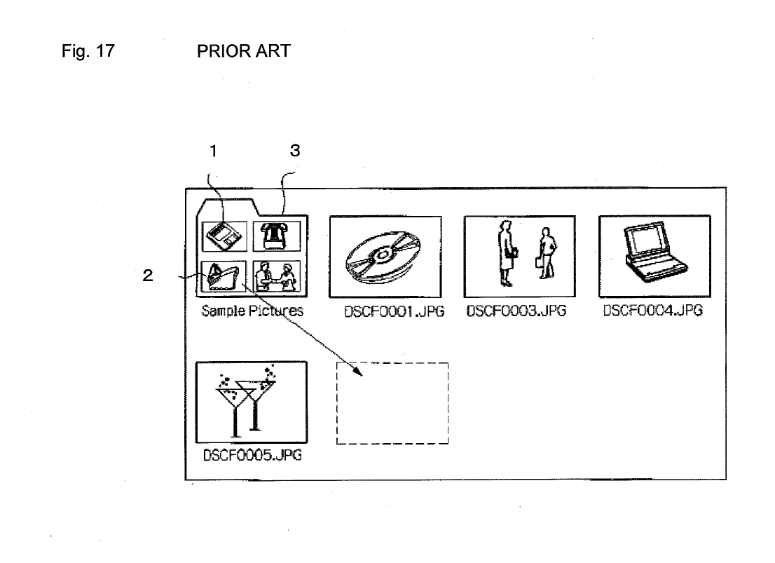

FIG. 18 is a front view illustrating another conventional electronic device in which thumbnails and direction change buttons are displayed.

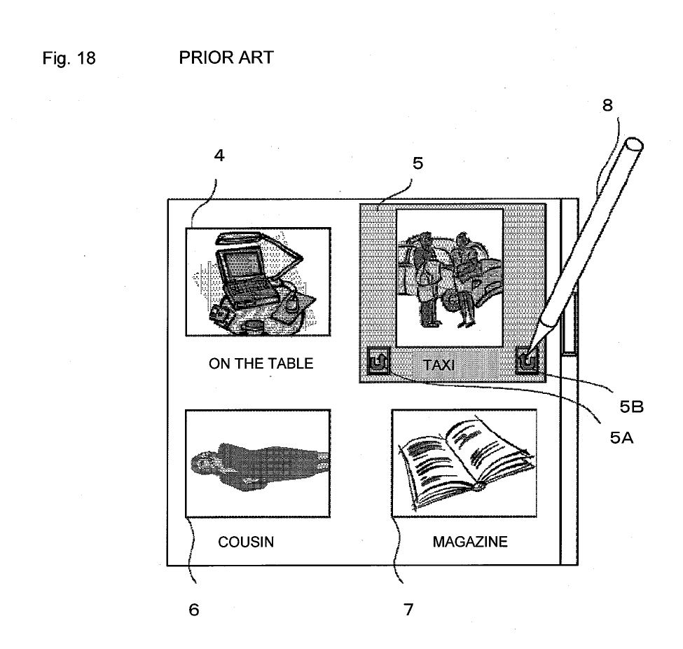

### PREFERRED EMBODIMENTS OF THE INVENTION

Hereinafter, an embodiment of a content reproduction device in accordance with the present invention is described with reference to the drawings.

Hereinafter, a content reproduction device of Embodiment 1 according to the present invention is described.

First, a whole outline of the content reproduction device of Embodiment 1 according to the present invention is described.

“About a Whole Outline of the Content Reproduction Device”

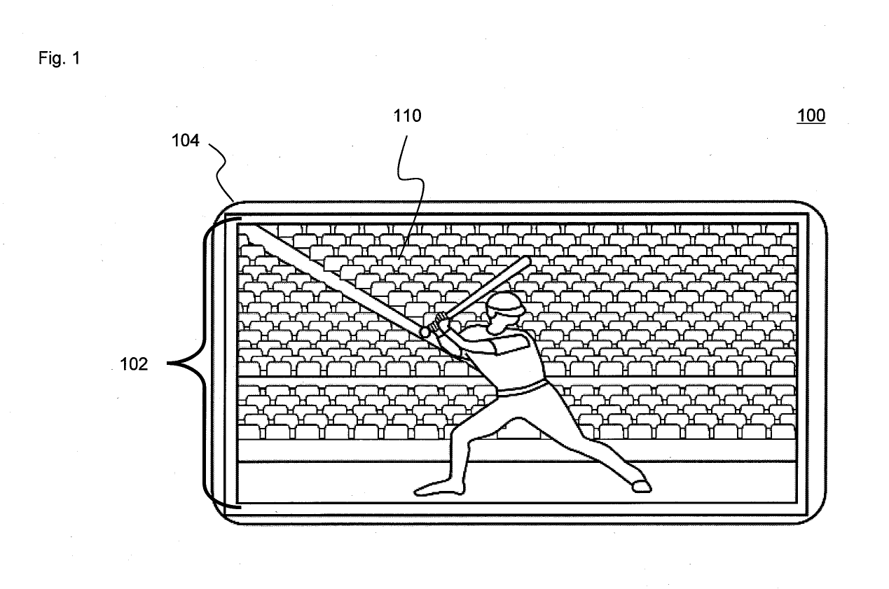

FIG. 1 is a front view illustrating the content reproduction device of the present Embodiment 1. As shown in FIG. 1, the content reproduction device of the present Embodiment 1 is equipped with a GUI, and is an electronic device with a recording function for recording a content 110. The content reproduction device 100 comprises a display panel 104 on which a screen 102 for reproducing the content 110 is disposed.

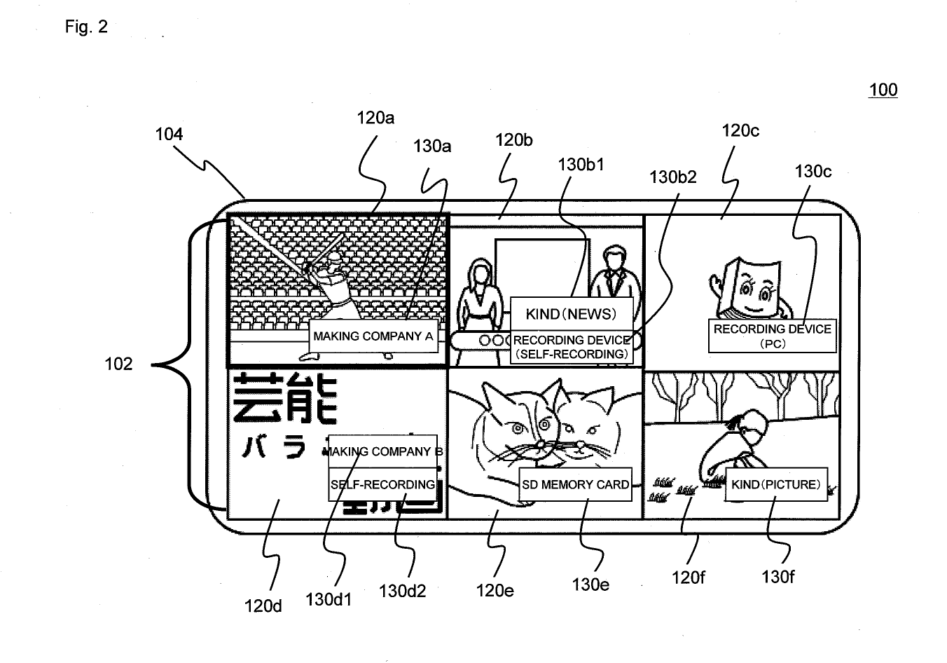

Moreover, FIG. 2 is a view illustrating a state of a display before the content 110 is being reproduced, and in the present Embodiment, is a view illustrating a state of a display of a top-level menu after turning on a power supply. As shown in FIG. 2, on the screen 102 of the display panel 104, plural thumbnails 120 corresponding to plural contents 110 and plural icons 130 showing a genre of each content 110 are displayed. This display panel 104 constitutes a touch-sensitive panel, and thumbnails 120 and icons 130 function as an input control unit for starting an application about the contents 110.

Generally, the content means a content or a creation created with a letter, a sound, a picture. By the law on promotion of creation, protection, and practical use of contents, a content is defined as follows. “A content means a movie, music, theater, literature, a photograph, comics, animation, a computer game, other character, a figure, a color, a sound, a movement, or an image, or what these are combined into, or a program (i.e. the instruction to an electronic computer, which is combined so that one result can be obtained) for providing information concerning these through an electronic computer, and means what belongs to a range of culture or amusement among what is produced by human's creative activity.”

Moreover, thumbnail 120 means an image on which a part of the content 110 is displayed in order to improve visibility, and an icon 130 means an image expressing the genre of the content 110 with a figure, a picture, a sign, a character, etc. A genre of the content 110 means a kind of content 110, a kind of media on which the content 110 is recorded, a kind of a content recording device which records the content, application (or application software) for recording the content 110, and an individual which creates or distributes the content 110, a creation company, a distribution company and others. In addition, the kinds of content 110 can include a photograph, a moving image, a piece of music and so on. The kinds of the media which records the content 110 can include a laser disk, a flash memory and so on. Moreover, the kinds of the content recording device can include self-recording, PC, a hard disc recorder and so on. Moreover, self-recording means that the content 110 is recorded with this content reproduction device 100. Moreover, as an example of a creation company or a distribution company, a television station, a distribution company, etc. which broadcast a program can be mentioned.

Next, the display of the top-level menu shown in FIG. 2 is described.

“About a Display of the Top-Level Menu of the Content Reproduction Device 100”

As mentioned above, on the top-level menu of the content reproduction device of the present Embodiment, plural thumbnails 120 corresponding to plural contents 110 and plural icons 130 showing genres of the contents 110 are displayed.

Specifically in FIG. 2, the six thumbnails 120 are displayed. On a thumbnail 120a at the left end of the upper row among these thumbnails 120, a part of a content 110 about sports program F (baseball) is displayed. Simultaneously, in the domain where this thumbnail 120a is displayed, the making company name (the making company A is shown in FIG. 2) which makes this content 110 is displayed as an icon 130a. That is, a user can easily identify that the content 110 is a sports program (baseball), and the company which makes this content 110.

Moreover, on a thumbnail 120b at the center of the upper row, a part of a content 110 about a news program G is displayed. Simultaneously, in the domain where this thumbnail 120b is displayed, a name (news) of a kind of this content 110 and a name of the recording device (self-recording) of this content 110 are displayed as icons 130b1, 130b2. That is, the user can easily identify that a kind of this content 110 is a news program, and that this content 110 is recorded with this content reproduction device 100.

Moreover, on a thumbnail 120c at the right end of the upper row, a part of a content 110 about a cartoon program E is displayed. Simultaneously, in the domain where this thumbnail 120c is displayed, a recording device (PC) of this content 110 is displayed as an icon 130c. That is, a user can easily identify that the content 110 is a cartoon program, and that the recording device which records this content 110 is a personal computer (PC).

Moreover, on the thumbnail 120d at the left end of a lower row, a part of a content 110 about an entertainment program D is displayed. Simultaneously, in the domain where the thumbnail 120d is displayed, a name of a making company which makes this content 110, and a name of a recording device (self-recording) of this content 110 are displayed as an icon 130d. That is, the user can easily identify that the content 110 is a performing art program, the name of the company which makes this content 110, and that this content 110 is recorded with this content reproduction device 100.

Moreover, on a thumbnail 120e at the center of the lower row, a part of a content 110 about an animal moving image I is displayed. Simultaneously, in the domain where this thumbnail 120e is displayed, a media (SD memory card) on which this content 110 is recorded is displayed as the icon 130e. That is, the user can easily identify that the content 110 is a content about an animal, and the media (SD memory card) on which this content 110 is recorded.

Moreover, on a thumbnail 120f at the right end of the lower row, a part of content 110 of a child photograph K about a child is displayed. Simultaneously, in the domain where this thumbnail 120f is displayed, a kind (photograph) of this content 110 is displayed as an icon 130f. That is, the user can easily identify that the content 110 is a content about a child, and that the kind of this content 110 is a photograph.

Thus, in the present Embodiment, the thumbnails 120 of plural contents 110 are displayed on the screen 102. And in the domain where each thumbnail 120 is displayed, the icon 130 of the genre to which the content 110 of each thumbnail 120 belongs is displayed.

Next, a database included in the content reproduction device 100 of the present Embodiment is described. In the present Embodiment, the database is stored in an internal memory 52 mentioned later, but it can be configured such that the database is stored in an external memory and is referred to, when required.

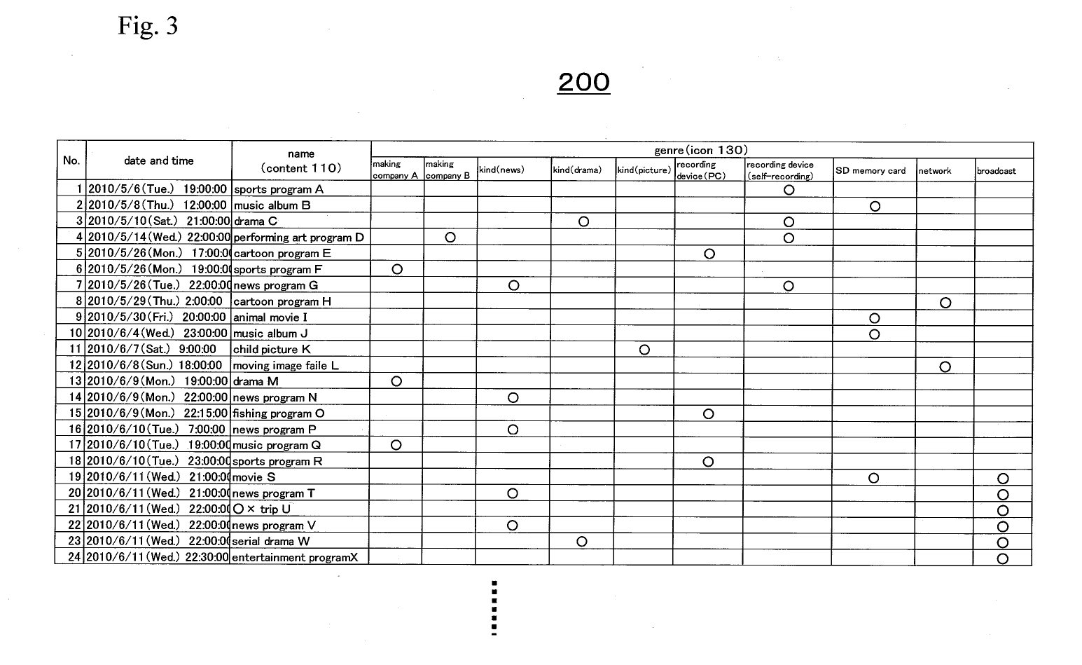

FIG. 3 is a view illustrating an example of the database which is included in the content reproduction device 100 of the present Embodiment. As shown in FIG. 3, in the database 200 of the present Embodiment, names of contents are indicated in order of the date, and genres to which the contents belong is indicated. In the present Embodiment, for example, the date can be considered the date and time of recording in the recorded contents, the date and time of preserving the photograph contents, the date and time of downloading in the musical contents, and the date and time of registering to the database 200 in contents 110 on the network. In addition, it is not necessary to restrict to this, and the date can be considered the newest date and time etc. when the content is perused, and changing suitably is possible. Moreover, in the contents 110 of broadcast, programs to be broadcast are registered into the database 200, and can be set up beforehand to be arranged in order, such as beginning with an earliest start time, and beginning with a small channel number. Moreover, it is not necessary for an order of the contents 110 to be determined by paying attention to the date, and an order of the contents 110 can be determined by paying attention to a name, content of each genre, etc, and an order of the contents 110 can be determined by paying attention to an item specified by a user. Thus, an order of the contents 110 can be determined based on any kind of item.

In the database 200 in FIG. 3, for example, the content 110 of music album B which is indicated as No. 2 in the database 200 in FIG. 3 is stored in the SD memory card. Moreover, it is shown that the content of news program G indicated as No. 7 is a news program, and is a content self-recorded, and belongs to two genres. In addition, this database 200 can be updated manually by a user and can be updated automatically.

Moreover, a content 110 of a cartoon program H indicated as No. 8 in the database 200 and a content 110 of a moving image file L indicated as No. 12 are contents on a network, and are registered into the database 200 by the user.

Moreover, contents 110 indicated from No. 19 to No. 24 of the database 200 are contents 110 belonging to the genre of broadcast, and are contents of the program of each broadcasting station to be broadcast. In addition, the contents indicated as No. 19 to No. 24 of the database 200 are contents acquirable from an EPG (Electric Program Guide) etc. through the television signal receiving unit 30 and the network data processing unit 40 which are mentioned later.

The content reproduction device includes the database 200 which lists all of contents 110, and also includes a database for each genre. In this case, when a content belongs to two or more genres, the content is registered in plural databases.

Next, a configuration of the content reproduction device 100 of the present Embodiment is described.

“About the Configuration of the Content Reproduction Device 100”

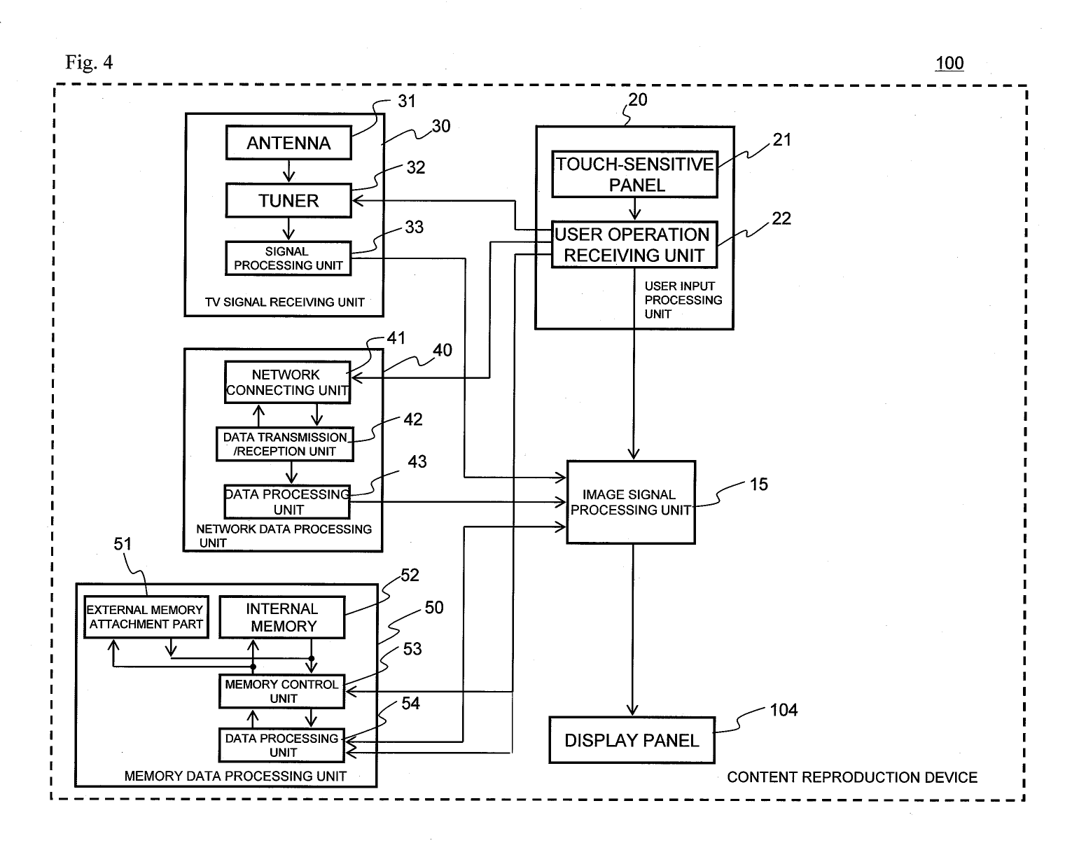

FIG. 4 is a configuration view illustrating the content reproduction device according to the present Embodiment. As shown in FIG. 4, the content reproduction device according to the present Embodiment has a display panel 104, an image signal processing unit 15, a user input processing unit 20, a TV signal receiving unit 30, a network data processing unit 40 and a memory data processing unit 50.

The display panel 104 displays the reproduction image of an image signal, for example, a moving image obtained by reproducing a content file, the thumbnail 120 of the content 110, the icon 130, and so on. A liquid crystal panel generally used can be mentioned as an image display device which constitutes the display panel 104. In the present invention, a device which constitutes the display panel 104 need not be restricted to a liquid crystal panel, and another device such as a plasma display panel and an EL (Electro Luminescence) panel can be adopted as the device which constitutes the display panel 104.

The user input processing unit 20 has a touch-sensitive panel 21 and a user operation receiving unit 22.

In the present Embodiment, a touch-sensitive panel 21 is used as a user interface unit for receiving an operation by a user. The touch-sensitive panel 21 constituted by an electric capacitive method generally used is adopted. In the present invention, the touch-sensitive panel 21 need not be restricted to the electric capacitive method and other methods such as a resistance film method or a surface elastic wave method can be adopted as the touch-sensitive panel 21.

As mentioned above, the touch-sensitive panel 21 is attached over all of an image display surface of the display panel 104. Thereby, in the content reproduction device 100, enlargement of the screen of the display panel 104 is possible. And the user can operate the content reproduction device 100 through this touch-sensitive panel 21.

The user operation receiving unit 22 receives an instruction when the user operates the touch-sensitive panel 21 to input the instruction into the content reproduction device 100. This user's operation means, for example, an operation of selecting the genre of a content file, an operation of selecting a thumbnail 120 showing a desired content file from plural thumbnails 120 which are displayed on the display panel 104, an operation of selecting an icon 130 displayed in a domain where the thumbnail 120 is displayed, an operation of selecting a channel of television broadcasting, and so on. In addition, the operation of selecting the genre of the content file is an operation that the user determines a genre to which the content 110 belongs when the content 110 is registered in the database 200.

The TV signal receiving unit 30 has an antenna 31, a tuner 32 and a signal processing unit 33.

An antenna 31 receives the television broadcasting signal. The tuner 32 takes an image signal (or image data), an audio signal (or data under voice), a data-broadcasting signal (or data for data-broadcasting), etc. of a channel set up by a user operation from television broadcasting signals received with the antenna 31.

The signal processing unit 33 transforms the image signal (or image data) outputted from the tuner 32 into an image signal which can be processed in the image signal processing unit 15.

The network data processing unit 40 has a network connecting unit 41, a data transmission/reception unit 42, and a data processing unit 43.

The network connection unit 41 is connected to a network (for example, the Internet, a home network, etc.), and exchanges data with other devices through the network.

The data transmission/reception unit 42 receives a data transmitted from other devices via a network through the network connecting unit 41. This receiving data is a content file, etc. which is distributed through a network by the data sharing service that, for example, plural network users share the content file through a predetermined server computer.

Moreover, the data transmission/reception unit 42 transmits the data transmitted to other devices via a network to other devices through the network connecting unit 41. This transmission data is, for example, a data for requiring the content file for which a user asks based on the user's operation received by the user operation receiving unit 22, etc.

The data processing unit 43 transforms an image data contained in the content file received in the data transmission/reception unit 42 into an image signal which can be processed in the image signal processing unit 15.

A memory data processing unit 50 has an external memory attachment part 51, an internal memory 52, a memory control unit 53, and a data processing unit 54.

The external memory attachment part 51 is configured so that a small memory storage (for example, memory card like an SD memory card, etc. Hereafter, it is described as an “external memory.”) is detachable and attachable, and exchanges data with an external memory attached to the external memory attachment part 51.

The internal memory 52 comprises small memory storage, such as a semiconductor memory, and accumulates a contents file etc. That is, the internal memory 52 or an external memory functions as a content storing unit. In addition, as mentioned above, the database 200 shown in FIG. 3 is also stored in the internal memory 52.

The memory control unit 53 controls the internal memory 52 and the external memory which is attached to the external memory attachment part 51. And, the memory control unit 53 reads the content file and memory accumulation data, such as ranking data etc. which is given to the content file. Or the memory control unit 53 writes the content file or the ranking data etc. which should be given to the content file in the internal memory 52 or an external memory. Specifically this ranking data corresponds to “No.” of the database 200 in FIG. 3, or “No.” of the list 140 mentioned later.

The data processing unit 54 transforms the image data contained in the content file read by the memory control unit 53 into the image signal which can be processed by the image signal processing part 15. Alternatively, the data processing unit 54 transforms the television broadcasting signal received by the TV signal receiving unit 30 or the contents file by the network data processing unit 40 into the data which can be written in the external memory or the internal memory 52.

The image signal processing unit 15 selects any one of the image signal transmitted from the signal processing unit 33, the data processing unit 43, and the data processing unit 54 based on the user operation received in the user operation reception part 22, and outputs it to the display panel 104. Moreover, the image signal processing unit 15 creates the thumbnail 120 for every content based on the image signal transmitted from the signal processing unit 33, the data processing unit 43, and the data processing unit 54, and also outputs the created thumbnail 120 to the display panel 104. In addition, as mentioned above in connection with FIG. 2, this thumbnail 120 means a reduced image displayed on the display panel 104 as a sample which expresses the content file, and by displaying the thumbnail 120, operation of selecting arbitrary content file from plural content files can be made easy.

The image signal processing unit 15 displays the content 110 (reference to FIG. 1), and the thumbnails 120 of the contents 110 and the icons 130 as shown in FIG. 2. When the thumbnail 120 and the icon 130 are displayed, as shown in FIG. 2, the icon 130 is displayed in the domain where the thumbnail 120 is displayed.

Next, the movement of the content reproduction device of the present Embodiment according to the present invention is described and an example of the content reproduction method of the present invention is described.

“About a Flow of Operation of the Content Reproduction Device 100”

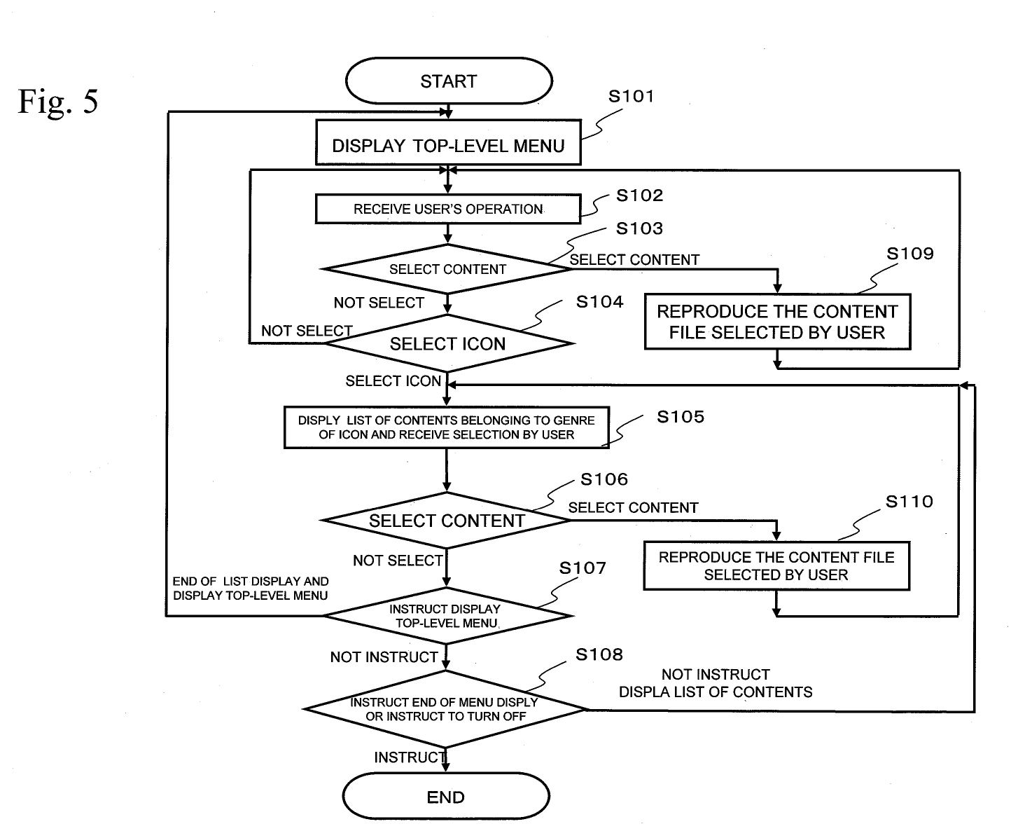

FIG. 5 is a flow view illustrating the content reproduction device according to the present invention. In addition, a step is abbreviated to S in the present Embodiment. Moreover, detailed explanation of a display is mentioned later.

First, the content reproduction device 100 displays the top-level menu which is an initial screen of the content reproduction device (S101). In the present Embodiment, as an example of a top-level menu, plural thumbnails and icons as shown in FIG. 2 are displayed. This S101 corresponds to an example of the thumbnail-icon display step. In the content reproduction device 100, a top-level menu can be restricted to the screen of FIG. 2. For example, it can be constituted such that, as a top-level menu, a device setting menu and a content menu, etc. are displayed and that when the content menu is selected, the screen shown in FIG. 2 is displayed. The device setting menu is a menu for adjusting functions of device itself, such as brightness of the screen and volume of the content reproduction device 100 itself. The content menu is a menu for selecting and displaying the content, etc.

Then, an operation by the user is received in the user input processing unit 20 (S102). The operation by the user is received by detecting the pushed position with the touch panel 21 etc.

Then, it is judged whether the thumbnail 120 or the icon 130 exists at the pushed position (S102, S103). Specifically, since a display of the display panel 104 is a display of a top-level menu, a display of the display panel 104 is in the state shown in FIG. 2 and the thumbnail 120 or the icon 130 is selected.

When the position pushed by the user is the thumbnail 120, it is judged that the content 110 of the thumbnail 120 is selected (S103), and reproduction of the selected content 110 is performed (S109; movement to the selection of the content in S103).

When the selected content 110 is the content 110 stored in the content reproduction device 100, the content file, etc. obtained by a memory data processing unit 50 is transformed into the image signal which can be processed in the image signal processing unit 15 and is displayed with the display panel 104.

When the selected content 110 are the contents 110 on a network, the content file etc. which were obtained by the network data processing unit 40 is transformed into the image signal which can be processed in the image signal processing unit 15, and is displayed with the display panel 104.

In reproduction of the content 110 of 5103, when the selected content 110 is the content 110 of broadcast, a TV signal is received by the TV signal receiving unit 30, and is transformed into an image signal which can be processed by the image signal processing unit 15, and is displayed on the display panel 104. For example, as shown in FIG. 1, television broadcasting is displayed to the limit of the screen of the display panel 104.

When the pushed position is the icon 130, it is judged that the icon 130 is selected (S104), and the screen according to the icon 130 is displayed (progress from S104 to S105 through the selection of icon 130).

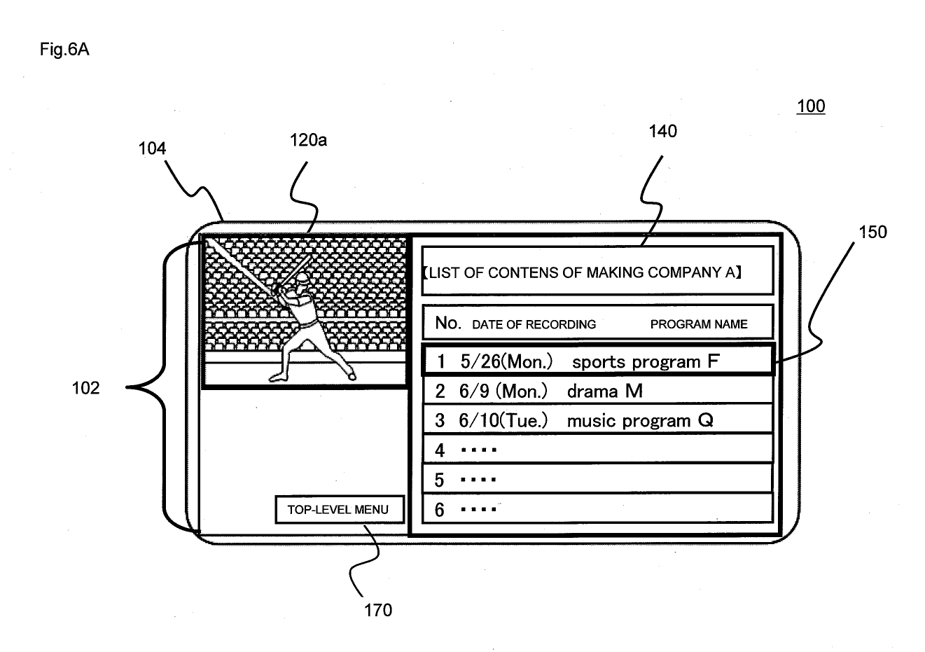

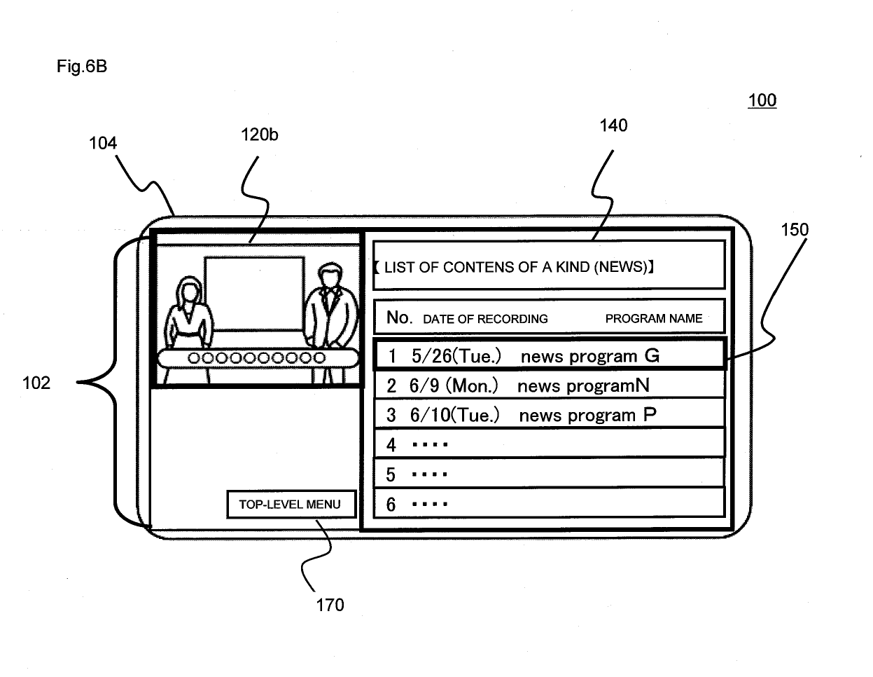

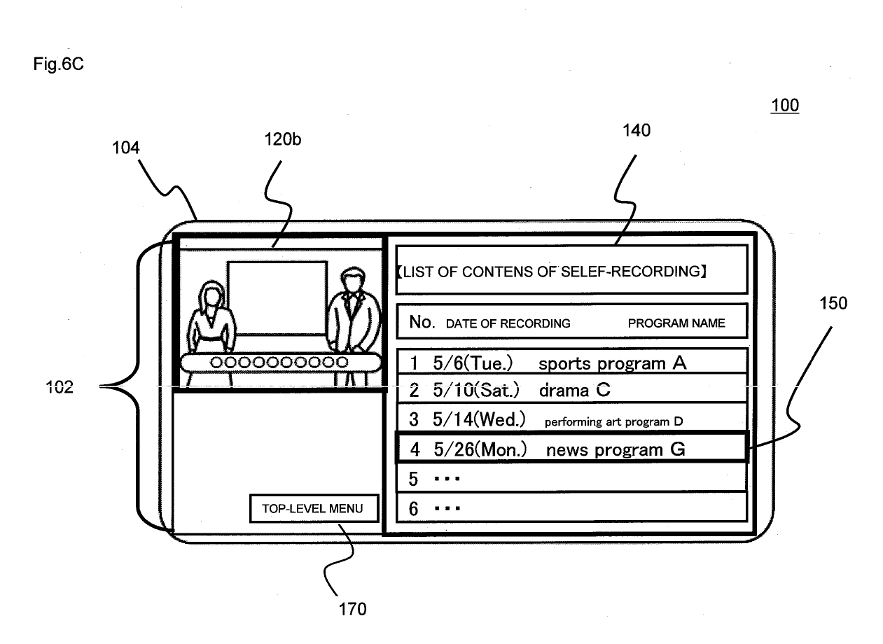

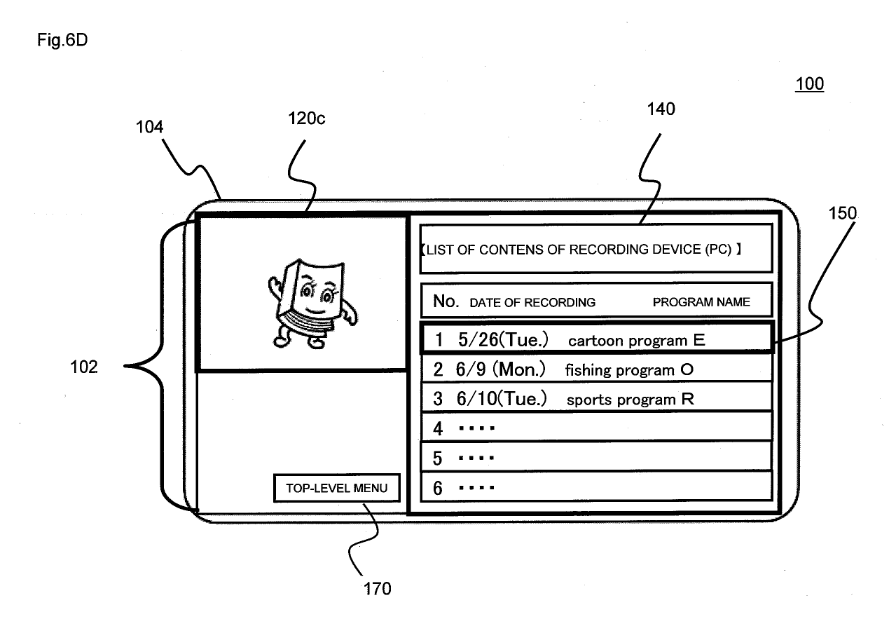

When the icon 130a shown in FIG. 2 is selected in S104, in S105, the screen as shown in FIG. 6(A) is displayed, and the list of contents 110 relevant to the function selected by the icon 130a and the thumbnail 120a of the temporarily selected content 110 are displayed.

A user selects the desired content 110 from the list of contents. The selection of the content 110 is received by the user input processing unit 20.

When an item selected by user is the thumbnail 120a of the content 110 or is one of content 110 shown by the list of contents, reproduction of the content 110 selected by user is performed (progress from S106 to S110 through the selection of the content)

When the selection of the contents 110 is not made, a judgment whether the end of the list display of the contents 110 is made by the user, namely whether the instruction of displaying a top-level menu is received, is performed. When the instruction of displaying a top-level menu is received, step progresses to the top-level menu display of S101. Specifically, a top-level menu icon 170 shown in FIG. 6(A) is selected, and a display changes to the top-level menu shown in FIG. 2.

When the top-level menu icon 170 is not selected but an end of a menu display of the content reproduction device 100 or an instruction, such as power supply OFF, by the user is received (progress to S108), a display is ended. In addition, the manual operation button is separately prepared for power supply OFF, and a power supply can be turned off with the manual operation button. Moreover, in order to end a menu display, the icon of the end of a menu display can be prepared above the top-level menu icon 170.

When instructions of the end of the top-level menu display, the end of the menu display and power supply OFF are not given, the display of a list of contents is continued (progress from S108 to the display the list of the content, and progress to S105).

The display of the thumbnail 120 of the content 110 selected by user, or the display of the function of icon selected, etc. is performed by repeating the above-mentioned procedure S101 to S110.

In addition, an example of the screen display step of the present invention corresponds to S105 and S109 of the present Embodiment.

Hereinafter, content of a display and content of processing in each screen of operation of the content reproduction device 100 mentioned above are described in detail.

First, the display of a top-level menu is described.

“About the Top-Level Menu of the Content Reproduction Device 100”

In the top-level menu displayed in 5101 mentioned above, as shown in FIG. 2, the thumbnails 120 of the six contents 110 are displayed. These six contents 110 are chosen beforehand. In the present Embodiment, for example, six genres are beforehand set up by the user and the contents of which the thumbnail 120 is displayed in each genre are selected beforehand. For example, in the display of FIG. 2, the contents 110 with the oldest date in each genre are chosen (reference to FIG. 3). The content 110 with the oldest date means the oldest content of the recorded day, the saved day, etc. And the icon 130 of the genre to which the selected content 110 belongs is displayed in the domain where the thumbnail 120 of the contents 110 is displayed. For example, although the contents belonging to the creation company A are the content belonging to No. 6, No. 13, and No. 17 of the database 200 in FIG. 3, the No. 6 content being the oldest content is displayed as shown in FIG. 2.

In addition, the content 110 of the news program G of the thumbnail 120b is the oldest content in the genre of the kind (news), but it also belongs to the genre of self-recording, so the two icons 130b1, 130b2 are displayed in the domain where the thumbnail 120b is displayed. In the present Embodiment, the thumbnail 120 of the oldest content 110 in the genre of the icon 130b1 arranged up is displayed.

In addition, the displayed content can not be restricted to the content 110 with the oldest date in each genre, and the content 110 with the newest date can be displayed, and the content 110 with more number of times of user's use can be displayed. The displayed contents can be selected on the basis of the use date and time, and the displaying contents can be selected on the basis of the making date. In addition, when the contents is selected on the basis of the number of times of using, the date and time of using, or the date of making, information of the number of times of using, the date and time of using, or the date of making is registered into the database 200 for every content 110. Moreover, when the content 110 is a moving image, for example, the number of times of using can be considered as the number of times of reproducing, and when the content 110 is a static image, for example, the number of times of using can be considered as the number of times of inspecting. Moreover, it is not necessary to restrict these standards, and the content 110 can be selected on the basis of a name, and a selection standard can be changed for every genre, and a user can specify the contents 110 selected. Thus, the content 110 of which the thumbnail 120 is displayed can be selected on the basis of any standard.

Moreover, six contents to display can be beforehand selected by the user instead of selecting six genres.

Furthermore, in FIG. 2, although the six thumbnails 120 are displayed, the displayed thumbnails can not be restricted to six thumbnails. By reduction of display of the thumbnail 120, many more thumbnails 120 can be displayed. Moreover, only the six thumbnails 120 are displayed on a screen and other thumbnails 120 can be displayed by scroll. This scroll button can be constituted of touch-sensitive panel 21, a manual operation button can be arranged, and control of a display can be performed such that the screen is scrolled by moving a finger vertically and horizontally.

Next, a display of the list 140 of the contents 110 is described when the icon 130 is selected in S104.

“About the Display of the List 140 of the Contents 110”

As mentioned above, in the content reproduction device 100 shown in FIG. 2, plural thumbnails 120 corresponding to plural contents 110 and icons 130 showing the genres of the contents 110 are displayed in the top-level menu.

A part of a content 110 about sports program F (baseball) is displayed on the thumbnail 120a at the left end of the upper row. Simultaneously, the making company name which makes this content 110 is displayed in the domain where this thumbnail 120a is displayed, on the icon 130a as the making company A. For example, when the icon 130a showing this making company A is selected, the application about the content 110 starts. This application is an application which displays the list 140 of the contents 110.

Here, the contents 110 belonging to the genre (making company A) to which the icon 130a belongs is selected from the database 200 shown in FIG. 3 by the data processing unit 54, and the selected contents 110 are given numbers in order of the date. And the selected contents 110 are sent to the image signal processing unit 15, and are displayed as the list 140 with the display panel 104.

FIG. 6(A) is a view illustrating the screen on which the list 140 is displayed. As shown in FIG. 6(A), the thumbnail 120a showing a part of content 110 and the list 140 of the contents 110 made by this making company are displayed on the screen 102. Titles, such as a sports program name, a drama name, and a musical program name, are displayed on the list 140 of these contents 110 with information of a date of recording etc. Then, the program name of the content 110 is surrounded by the selection frame 150 so that the correspondence relation between the program name and the date of recording of the content 110 corresponding to the thumbnail 120 can be judged. Specifically, the No. 6, the No. 13, and the No. 17 contents 110 of the database 200 of FIG. 3 are displayed on the list 140.

Thus, in the state of the display of FIG. 6(A), which is displayed by the selection of the icon 130a, the thumbnail 120a (sports program F), which is simultaneously displayed as the icon 130a in FIG. 2, is displayed, and the information on the content 110 of the thumbnail 120a (a program name and a date of recording being May 26 (Mon.) etc.) is surrounded by the selection frame 150. That is, the thumbnail 120a displayed in the top-level menu is also displayed in the display screen of the list 140. Thus, since the same thumbnail 120a is also displayed after the change from FIG. 2 to the screen FIG. 6(A), the continuity of operation is maintained, thereby increasing the ease of operation for the user. In addition, when a program name of another content 110 which is not surrounded by the selection frame 150 is selected, the thumbnail 120 corresponding to the program name is displayed, and the program name is surrounded by the selection frame 150.

Moreover, a part of the content 110 about news program G is displayed on the thumbnail 120b at the center of the upper row in FIG. 2. Simultaneously, in the domain where this thumbnail 120b is displayed, a kind name (news) of this content 110 and a recording device name (self-recording) of this content 110 are displayed as the icon 130. For example, when the icon 130b1 showing the kind name (news) of this content 110 is operated, as shown in FIG. 6(B), in the screen 102, thumbnail 120b displaying a part of the content 110 and a list 140 of the contents 110 which belong to the kind (news) of this content 110 are displayed. Titles, such as news program G, news program N, and news program P, are displayed on the list 140 of these contents 110 with information, such as a date of recording etc.

Then, the program of the content 110 is surrounded by the selection frame 150 so that the correspondence relation between the program name and the date of recording of the content 110 corresponding to the thumbnail 120 can be judged. In the state of the display of FIG. 6(A), which is displayed by the selection of the icon 130b1 as shown in FIG. 2, the thumbnail 120b, which is simultaneously displayed as the icon 130a in FIG. 2, is displayed, and the information on the content 110 of the thumbnail 120b (a program name and a date of recording being May 26 (Mon.) etc.) is surrounded by the selection frame 150. In addition, when a program name of other content 110 which is not surrounded by the selection frame 150 is selected, the thumbnail 120 corresponding to the program name is displayed, and the program name is surrounded by the selection frame 150.

On the other hand, in the display shown in FIG. 2, when the icon 130b2 showing the recording device name (self-recording) of the content 110 is operated, the screen shown in FIG. 6(C) is displayed. As shown in FIG. 6(C), the thumbnail 120b displayed in FIG. 2 and a list of the contents 110 belonging to the kind (self-recording) of this content 110 are displayed on the screen 102. The titles of a sports program A, a drama C, an entertainments program D, and a news program G recorded with the content reproduction device 100 are displayed with information of a date of recording etc. on the list 140 of this content 110.

Then, the program of the content 110 is surrounded by the selection frame 150 so that the correspondence relation between the program name and the date of recording of the content 110 corresponding to the thumbnail 120 can be judged. Here, in FIG. 6(C), the content (news program G) of the thumbnail 120b which is displayed on the screen of FIG. 2 is displayed on No. 4 of the list 140 unlike FIG. 6(B). In addition, when the icon 130b2 of the self-recording is selected in FIG. 2, thumbnail 120b of the oldest content 110 (sports program in May/6 (Tue.)) in the genre of self-recording can be displayed on the screen shown in FIG. 6(C). However, it is more preferable to display the thumbnail 120b, which is displayed on the top-level menu of FIG. 2, on the screen shown in FIG. 6(C) as well, because the user can recognize which icon the user selected and the continuity of operation is maintained.

Moreover, a part of the content 110 about a cartoon program is displayed on the thumbnail 120c at the right end of the upper row shown in FIG. 2. Simultaneously, in the domain where this thumbnail 120c is displayed, the recording device (PC) of this content 110 is displayed as the icon 130c.

For example, when the icon 130c showing this recording equipment (PC) is operated, as shown in FIG. 6(D), in Screen 102, the thumbnail 120c showing a part of the content 110 and the list 140 of contents 110 recorded in the recording device which records the content 110 are displayed. Titles, such as a cartoon program E, a fishing program O, and a sports program R, are displayed on the list 140 of these contents 110 with information of a date of recording etc. Then, the program of the content 110 is surrounded by the selection frame 150 so that the correspondence relation between the program name and the date of recording of the content 110 corresponding to the thumbnail 120 can be judged. In the state of the display of FIG. 6(D), which is displayed by the selection of the icon 130c as shown in FIG. 2, the thumbnail 120c, which is simultaneously displayed as the icon 130c in FIG. 2, is displayed, and the information on the content 110 of the thumbnail 120c (a program name and a date of recording being May/26 (Mon.) etc.) is surrounded by the selection frame 150. In addition, when a program name of other content 110 which is not surrounded by the selection frame 150 is selected, the thumbnail 120 corresponding to the program name is displayed, and the program name is surrounded by the selection frame 150.

The above-mentioned state shows a state at the time of operation of each icon 130a, 130b1, 130b2, 130c displayed on thumbnails 120a, 120b, 120c of the upper row, but, when icons 130d1, 130d2, 130e, 130f displayed on any one of thumbnails 120d, 120e, 120f of the lower row is operated, the list 140 of the contents 110 corresponding to this icon can be displayed. Moreover, the list 140 of the contents 110 is displayed on the right-hand side of the thumbnail 120 displayed on the upper left, but can be displayed under the thumbnail 120 of the upper row, or can be displayed on the thumbnail 120 in piles. In short, the list 140 can just be displayed somewhere in screens 102.

In addition, “the icon 130 being operated” said here means the state where the contents reproduction device 100 recognizes that the specific icon 130 is selected. For example, when the display panel 104 of the content reproduction device 100 is formed by the touch-sensitive panel etc. and a user touches screen 102 of this touch-sensitive panel with a pen etc., the content reproduction device 100 recognizes that the specific icon 130 is selected.

Next, the state of the display is described when the content 110 is selected in S106 mentioned above and is reproduced.

“About the Selection and Reproduction of the Content 110”

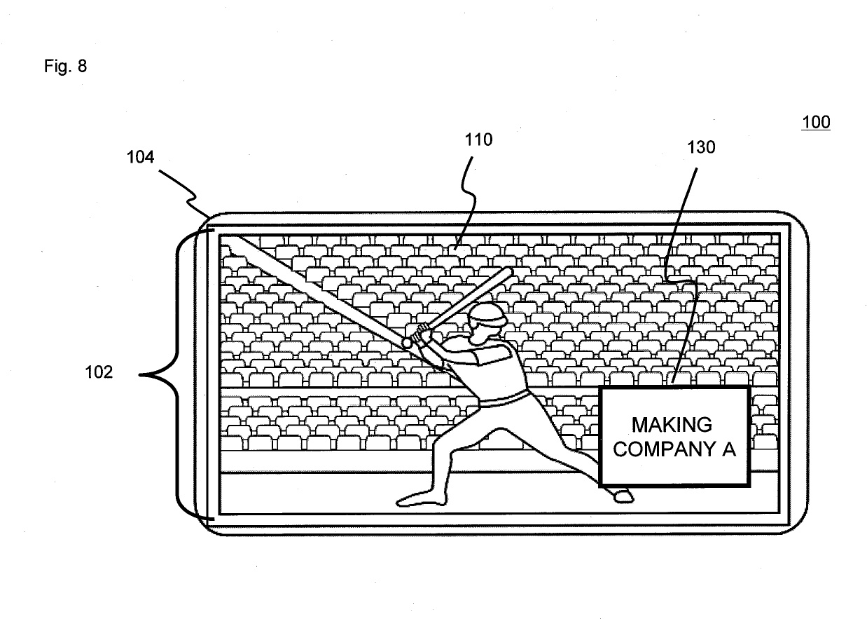

Suppose that, for example, the content 110 of sports program F already surrounded by the selection frame 150 is further selected from the state of the display in FIG. 6(A), a mesh cover part 160 is displayed inside the selection frame 150, and the application about the content 110 starts. This application is an application which reproduces the content 110, and, as shown in FIG. 8, the content 110 of sports program F is prominently displayed on the screen 102. The icon 130a of the making company is displayed, but the icon 130a can disappear, shortly after the content 110 is reproduced. The icon 130a is not displayed from the start of reproducing the content 110.

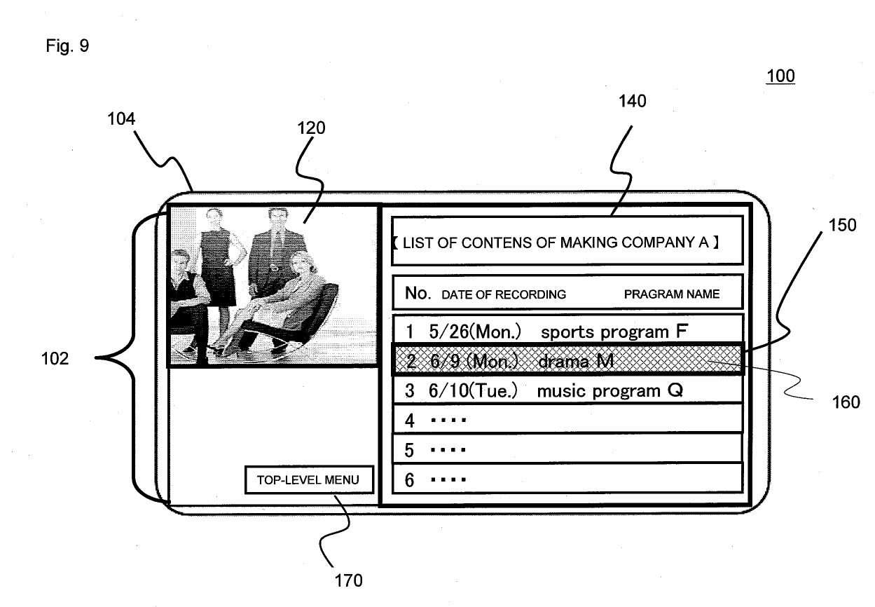

In addition, when the No. 2 content 110 (drama M) displayed on the list 140 is reproduced, as shown in FIG. 9 the No. 2 content 110 (drama M) of the list is surrounded with the selection frame 150 by the selection of the display of the column of the No. 2 content, and the thumbnail 120 of the No. 2 content 110 (drama M) is displayed. And when the No. 2 content 110 surrounded with the selection frame 150 is further selected, the mesh cover part 160 is displayed inside of the selection frame 150, and the application of the No. 2 content 110 (drama M) is displayed.

In FIG. 6(B), FIG. 6(C), and FIG. 6(D), the thumbnail 120b at the center of the upper row, and the thumbnail 120c at the right end of the upper row are the same. A user can select one content 110 from list 140 of the contents 110 corresponding to the thumbnail 120b of the center of the upper row to reproduce the one content 110, and can select one content 110 from list 140 of the contents 110 corresponding to the thumbnail 120c at the right end of the upper row.

In addition, the three thumbnails 120c, 120d, and 120e of the lower row are the same. By the operation of the icons 130c1, 130c2, 130d, 130e displayed on the domain where the three thumbnails 120c, 120d, 120e are displayed, the list of the content 110 is displayed, and one content 110 can be selected from the list 140 of the contents 110, and the one content 110 is reproduced.

Moreover, “selecting the content 110” said here means the state where the content reproduction device 100 recognizes that the specific content 110 is selected like the time of the icon 130 being operated.

Moreover, for example, when the content 110 displayed on the thumbnail 120a shown in FIG. 6(A) is reproduced, the content 110 is reproduced not only by selection of the content 110 from the list 140 of the contents 110, but also by the direct selection of the thumbnail 120a. “Selecting the thumbnail 120” said here means the state where the content reproduction device 100 recognizes that the specific thumbnail 120 is selected like the time of the content 110 being selected.

Next, the case where thumbnail 120g of the content 110 belonging to the genre of network and the thumbnail 120h of the content 110 belonging to the genre of broadcast are displayed on the top-level menu unlike the top-level menu of FIG. 2 is described.

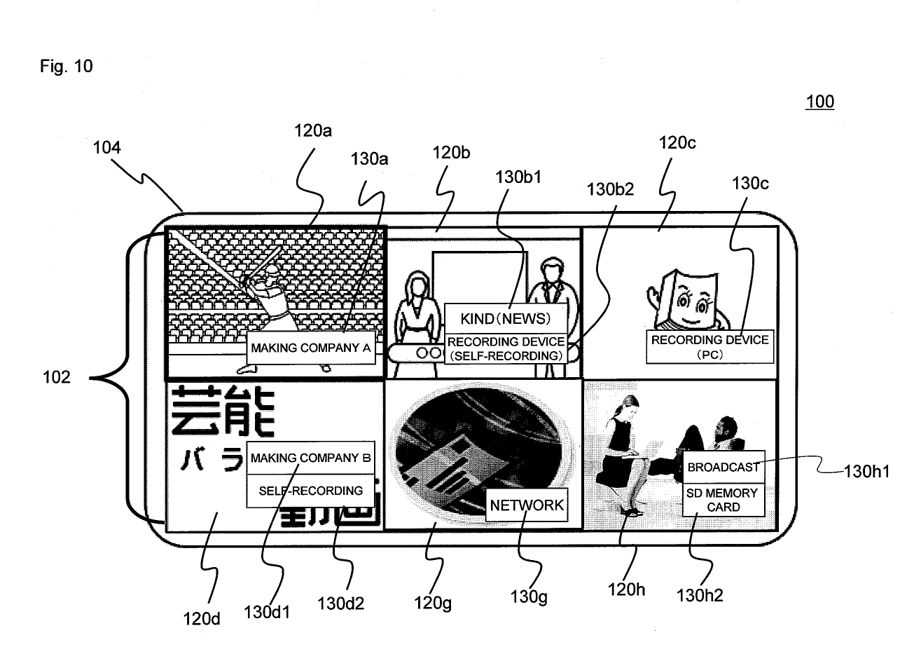

FIG. 10 is a view illustrating the display of a top-level menu which is different from the top-level menu in FIG. 2. In the display of the top-level menu shown in FIG. 10, thumbnail 120g of the No. 8 content 110 of cartoon program H of the database 200 is displayed. Moreover, the thumbnail 120h of the content 110 of the No. 19 content, movie S, of the database 200 is displayed. And in the domain where thumbnail 120g is displayed, icon 130g of the genre of the network is displayed, and in the domain where thumbnail 120h, icon 130h1 of the genre of broadcast and icon 130h2 of the SD memory card are displayed.

The contents 110 of the thumbnails 120 displayed on this top-level menu can be beforehand selected by the user, and can be automatically decided. For example, when the genre of the content 110 is a network, the thumbnail 120 of the oldest content 110 of the date can be displayed on a top-level menu with considering a registration date as a date of a database. Moreover, when the genre of the content 110 is broadcast, for example, thumbnail 120 can be displayed by how one screen is captured from the moving image of the first program among the programs put in order beginning with the earliest start time, and beginning with a small channel number. In addition, the thumbnail 120 of the contents 110 set up beforehand is displayed regardless of the date.

In the top menu of FIG. 10, when the thumbnail 120g is selected, the content 110 of cartoon program H is downloaded in the network data processing unit 40, and is displayed on the display panel 104 through the image signal processing unit 15.

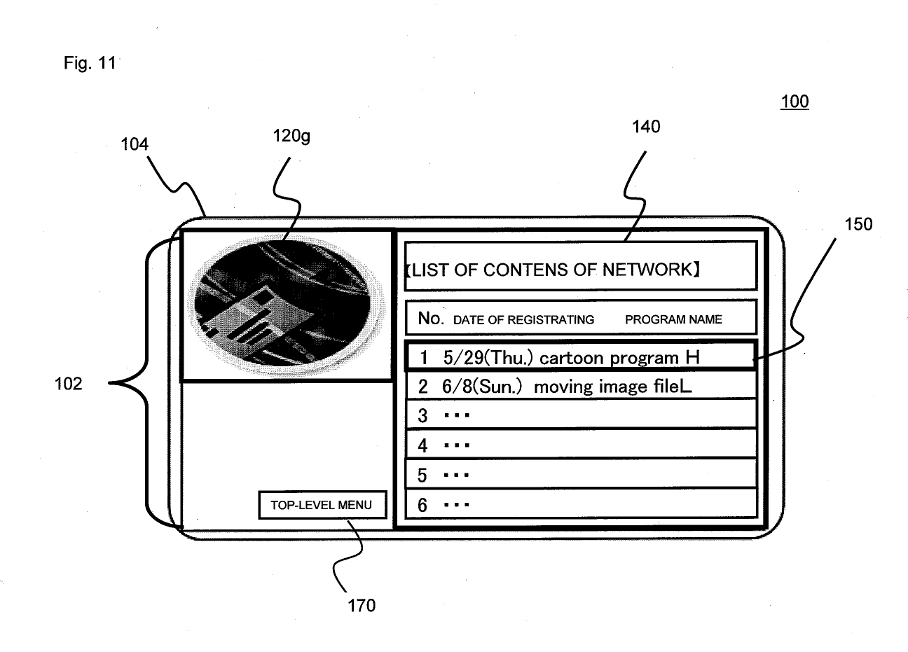

On the other hand, when the icon 130g displayed in the domain where the thumbnail 120g is displayed is selected, the list 140 of the content 1120 belonging to a genre of a network is displayed with thumbnail 120g as shown in FIG. 11. And when the display of the content 110 surrounded with the selection frame 150 is further selected, the above-mentioned mesh cover part 160 (not shown in figure) is displayed, and the selected content 110 is downloaded in the network data processing unit 40, and is displayed on the display panel 104 through the image signal processing unit 15. In addition, when the program which can be distributed on demand through a network is also made into the contents belonging to the genre of the network, the program can be displayed on the list 140 and can be searched.

Moreover, in the top-level menu of FIG. 10, when the thumbnail 120h is selected, the TV signal of the movie S is received by the TV signal receiving unit 30, and is transformed into an image which can be processed in the image signal processing unit 15, and is displayed on the display panel 104.

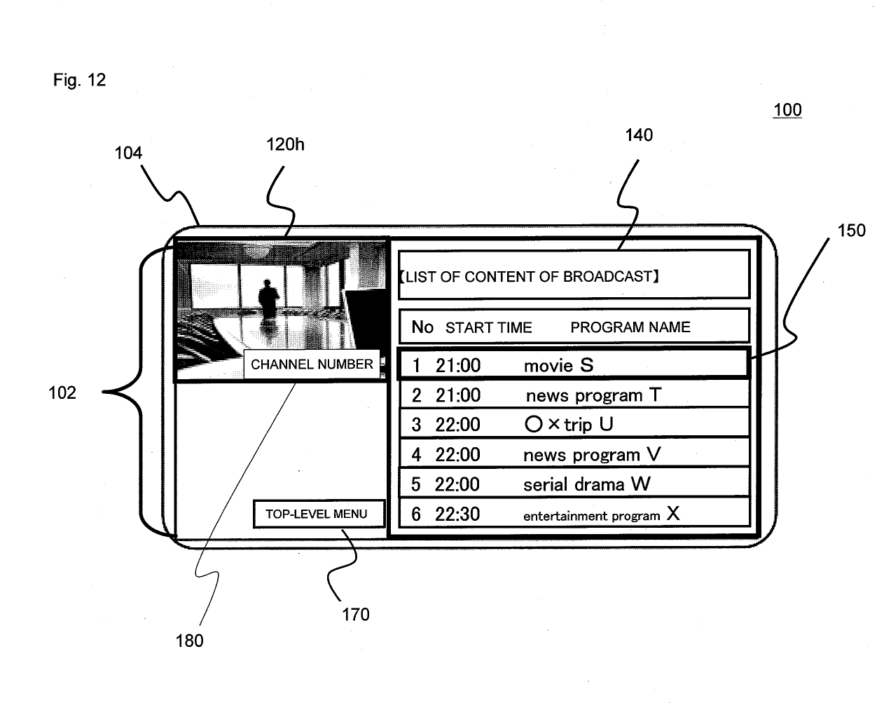

On the other hand, when an icon 130h1 displayed in the domain where the thumbnail 120h is displayed selected, as shown in FIG. 12, the list 140 of the contents 110 belonging to the genre of broadcast is displayed with the thumbnail 120h. Here, for example, when the present time is set to 22:45 on Jun. 11, 2010, the programs to be broadcast are displayed on the list 140 in the order of start time and increasing channel number. In addition, in the present Embodiment, the channel number is displayed on the channel display part 180 in the thumbnail 120, and can be displayed in the list 140.

And, the display of the content 110 surrounded by the selection frame 150 is further selected, the mesh cover part 160 (not shown in figures) is displayed, and the TV signal of the selected content 110 is received, and is transformed into the image which can be processed in the image signal processing unit 15, and is displayed with the display panel 104.

<Conclusion>

As mentioned above, according to the content reproduction device 100 of the present invention, since the control unit, which displays the thumbnail 120 of the content 110 and the genre of the content 110 simultaneously on a screen and displays the screen according to a selection result by receiving the selection result of the thumbnail 120 or the icon 130 from the user input processing unit 20, is arranged, search performance improves when the user searches a desired content from various contents which are recorded on various media by various applications and content recording devices, and the user can select the desired content easily and reproduce it.

That is, since the thumbnail 120 of the content 110 and the icon 130 showing the genre of the content 110 are simultaneously displayed on the screen 102 and the input operation unit for starting the application about the content 110 is the thumbnail 120 and icon 130, the user can select the desired content easily from various contents 110 recorded on various media by various applications and content recording devices and reproduce it.

That is, in the case that the application about the content 110 is such an application which, when the thumbnail is operated, reproduces the content 110 corresponding to the thumbnail 120, the content 110 can be easily reproduced (reference to FIG. 8).

Moreover, in case that the application about the content 110 is such an application which, when the icon 130 is operated, the list 140 of the contents 110 applicable-to the genre expressed by the icon 130 is displayed, then all the contents 110 related to the genre can be easily confirmed (reference to FIG. 6(A)). That is, if only corresponding to the genre to which the contents 110 of which the thumbnail 120 is displayed belong, various contents 110 recorded on various media by various applications and content recording devices can also be easily identified as the list 140 of plural contents 110.

Thus, it becomes possible to search easily the content 110 relevant to the one content 110, even if the user forgets the name and the place of a user's desired content file.

Moreover, when the user's desired content belongs to plural genres, the desired content is displayed in the list 140 by the operation of the icons of plural genres. Therefore, the desired content can be searched from many directions, and the user can search the desired content easily. For example, since the content of the news program shown in No. 6 of FIG. 2 can be searched from two directions that are the genre of a kind (news) and the genre of self-recording, it is possible to search from many directions.

Furthermore, in case that the application about the content 110 is such an application which, when one content 110 is selected from the list 140 of plural content 110 belonging to the same genre, reproduces the selected content 110, the selected content 110 can be easily reproduced.

Thus, even in case that various contents are recorded on various media by various applications and content recording device, the user can select easily the content 110 corresponding to the taste.

Moreover, since the icon 130 is displayed on the domain where the thumbnail 120 is displayed, it is not necessary to establish the domain where the icon 130 is displayed in a different part from the domain where the thumbnail 120 is displayed. Thereby, more thumbnails 120 and icons 130 can be displayed on the screen 102.

Moreover, since the related icon 130 is displayed in the domain where the related thumbnail 120 is displayed about the mutually related thumbnail 120 and the icon 130, the correspondence between the thumbnail 120 and icon 130 can be clear.

Moreover, when the thumbnail 120 is operated as an input operating unit, the application which reproduces the content 110 is started by the operation. Thereby, it is easy to reproduce the content 110.

Moreover, when the icon 130 is operated as an input operating unit, the application which displays the list 140 of the content 110 is started by the operation. Thereby, plural contents 110 can be identified at once.

Moreover, there are various forms besides the present Embodiment described as an application corresponding to the contents 110. It is important that the thumbnail 120 and the icon 130 are an input operation unit which makes the application corresponding to the contents 110 start. As an application, what is necessary is a function which improves a user's user-friendliness.

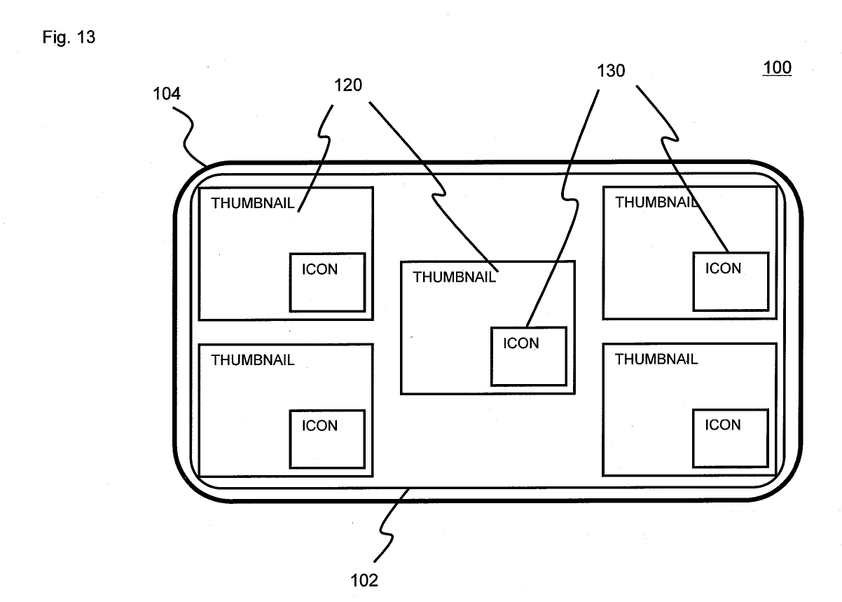

In addition, in the content reproduction device 100 of the present Embodiment, plural thumbnails 120 of the same size are arranged in rows on the whole screen 102, but, as shown in FIG. 13, the arrangement of the thumbnails 120 can be freely changed. In FIG. 13, one thumbnail 20 is arranged in the center of the screen 102, and four thumbnails are arranged on four squares of the screen 102. The thumbnail 120 arranged in the center can be such a thumbnail 120 of the content reproduced at the end, or such a thumbnail 120 which the user believes is important. The arrangement of the thumbnail 120 and the icon 130 can be freely changed according to a user's liking.

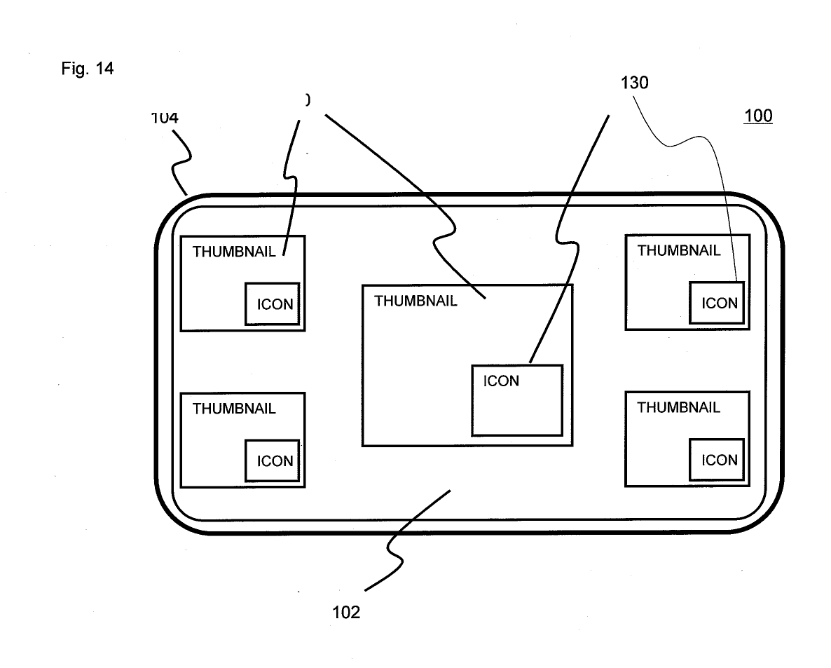

Moreover, as shown in FIG. 14, the size of the thumbnails 120 arranged on the screen 102 can be changed. In FIG. 14, size of the thumbnail 120 at the center of the screen 102 is made larger than the size of the thumbnail 120 arranged on four squares of the screen 102. The size of the thumbnail 120 is freely changed according to a user's liking.

Moreover, in the content reproduction device 100 of the present invention, the icon 130 is displayed on the domain where the thumbnail 120 is displayed, but the thumbnail 120 is displayed on the domain where the icon 130 is displayed.

Furthermore, plural thumbnails 120 and plural icons 130 can be simultaneously displayed on the screen 102, and about the mutually related thumbnail 120 and the icon 130, the related thumbnail 120 can be displayed in the domain where the related icon 130 is displayed.

Moreover, the thumbnail 120 or the icon 130 is not displayed in the domain where one of them is displayed, and the thumbnail 120 and the icon 130 can be displayed separately. In short, what is necessary is just to display the thumbnail 120 and the icon 130 on screen 102 simultaneously.

In addition, as shown in the thumbnail 120b of FIG. 2, when the content 110 belongs to plural genres, the icons 130b1, 130b2 which show plural genres, and are displayed in the above-mentioned Embodiment, only one of the icons 130b1, 130b2 can be displayed

Moreover, when the icon 130 is operated, or the contents 110 is selected or the thumbnail 120 is selected, in the present Embodiment, a touch-sensitive panel method is adopted, and the thumbnail and the icon are a touch-sensitive panel method, but the manual operation button is formed in the content reproduction device 100 instead of a touch-sensitive panel, and this manual operation button can be operated and the recognition is performed. It is adopted the composition that a determination button is disposed at the center and the direction buttons are disposed at the four directions of the determination button as this manual operation button.

Moreover, as shown in FIG. 6(A), the list 140 of the contents 110 and the thumbnail 120a are simultaneously displayed in the present Embodiment, but the thumbnail 120a can not be displayed.

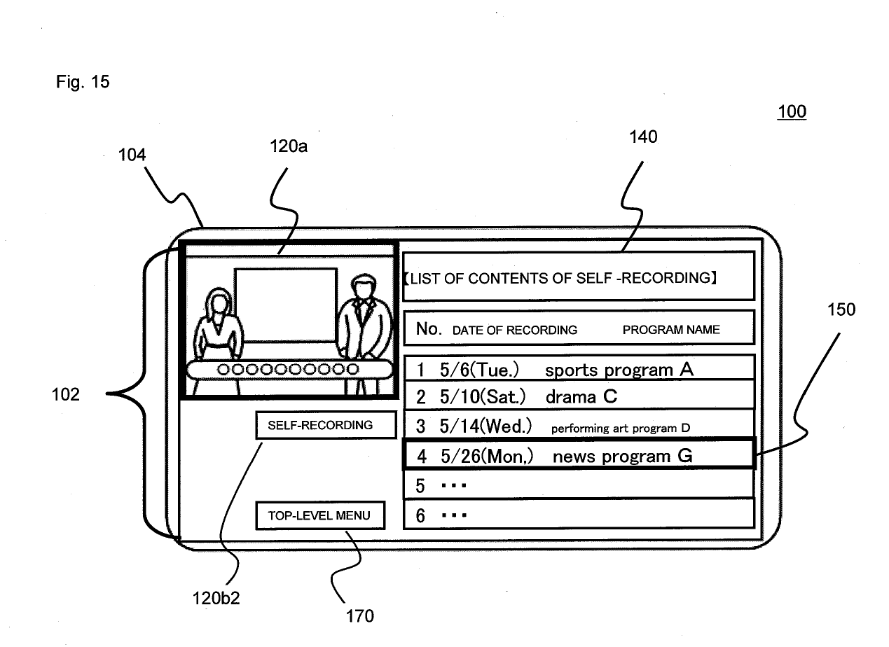

Moreover, in the present Embodiment, when the icon 120b1 is selected in FIG. 2, the display shown in FIG. 6(B) is performed, but, as shown in FIG. 15, the icon (icon 120b2 concerning self-recording in FIG. 11) of other genres can be displayed under the thumbnail 120b.

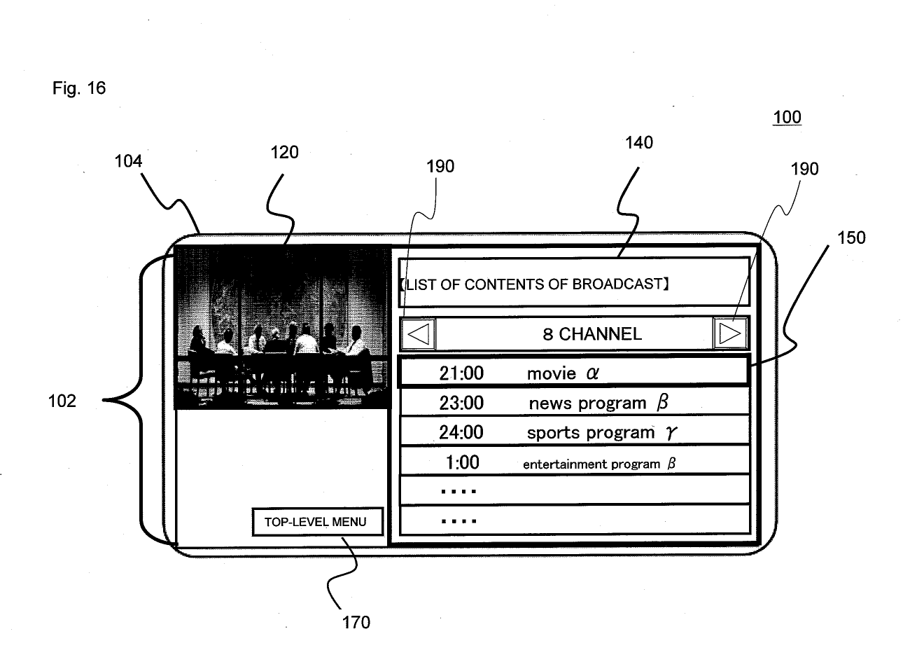

Moreover, in the above-mentioned present Embodiment, as shown in FIG. 12, the program to be broadcast is described in the list 140 as the contents 110 belonging to the genre of broadcast, but the program table which is due to be broadcast from now on can be displayed on the list 140. In this case, as a display, composition of FIG. 16 can be adopted. In the screen shown in FIG. 16 the program table of eight channels is expressed as the list 140. And, by the selection of a channel change unit 190 which is disposed at the right and left of the display part of a channel, the channel can be moved. The program table displayed on a list is also changed to that of the moved channel according to the movement of a channel. In addition, when the program which is to be broadcast, such as sports program shown in FIG. 16, for example, is selected, the program information etc. which is acquired from EPG is displayed as a thumbnail. Recording reservation etc. can be performed based on this program information.

The list of program tables shown in FIG. 16 can be such a list of a program on demand that have been broadcast. In this case, the contents list of programs which broadcast has already ended is indicated, and a program is distributed by the selection of the desired program.

Moreover, the program of the present invention is a program for causing a computer to execute the operations of each step of the above-described content reproduction method of the present invention, and is a program which operates in cooperation with the computer.

Moreover, the recording medium of the present invention is a recording medium which records a program for making a computer execute all or a part of operation of all or each step of the content reproduction method of the present invention mentioned above and which is a readable by the computer, whereby the read program performs the operations in collaboration with the computer.

In addition, the above “the operation of each step” of the present invention means all or a part of operation of the step.

Moreover, one utilizing form of the program of the present invention can be an aspect of being recorded on a recording medium, ROM and the like, which can be read by a computer, and operating with collaborating with the computer.

Moreover, one utilizing form of the program of the present invention can be an aspect of being transmitted inside a transmission medium, transmission media such as the Internet, light, radio waves, and acoustic waves and the like, being read by a computer, and operating with collaborating with the computer.

Furthermore, a computer according to the present invention described above is not limited to pure hardware such as a CPU and may be arranged to include firmware, an OS and, furthermore, peripheral devices.

Moreover, as described above, configurations of the present invention may either be realized through software or through hardware.

### INDUSTRIAL APPLICABILITY

The content reproduction device and the content reproduction method according to the present invention have an effect that search performance can improve more, and is useful in the content reproduction device or the like.

### DESCRIPTION OF SYMBOLS

15 image signal processing unit
20 user input processing unit
21 touch-sensitive panel
22 user operation receiving unit
30 TV signal receiving unit
31 antenna
32 tuner
33 signal processing unit
40 network data processing unit
41 network connecting unit
42 data transmission/reception unit
43 data processing unit
50 memory data processing unit
51 external memory attachment part
52 internal memory
53 memory control unit
54 data processing unit
100 content reproduction device
102 screen
104 display panel
110 content
120 thumbnail
130 icon
140 list
150 selection frame
160 mesh cover part
170 top menu icon
180 channel display unit
190 channel change unit

What is claimed is:

1. A content reproduction device, comprising:
a display panel which displays a reproduction screen reproducing a content, a thumbnail of the content, and an icon about a genre to which the content belongs;
a user input processing unit which receives a selection of the thumbnail or the icon; and
a control unit which displays the thumbnail and the icon on the display panel simultaneously and displays a screen according to a result of the selection of the thumbnail or the icon received from the user input processing unit on the display panel.

2. The content reproduction device according to claim 1, wherein
the thumbnail and the icon are a touch-sensitive panel system, and compose the user input processing unit.

3. The content reproduction device according to claim 1, wherein
the control unit displays the icon about the genre to which the content of the thumbnail belongs in a domain where the thumbnail is displayed.

4. The content reproduction device according to claim 3, wherein
when plural genres to which the content belongs exist, the control unit displays plural icons corresponding to the plural genres.

5. The content reproduction device according to claim 3, wherein
the control unit displays plural thumbnails and plural icons on the display panel simultaneously and, in a domain where each thumbnail is displayed, displays the icon about the genre to which the content of the each thumbnail belongs.

6. The content reproduction device according to claim 1, wherein
when receiving a selection of the thumbnail, the control unit starts an application which reproduces the content.

7. The content reproduction device according to claim 1, wherein
when receiving a selection of the icon, the control unit displays a list of contents belonging to a genre to which the content belongs.

8. The content reproduction device according to claim 7, wherein
the control unit displays the thumbnail which is simultaneously displayed with the icon, with the list of the contents.

9. The content reproduction device according to claim 1, wherein
the thumbnail is a thumbnail of one content selected from plural contents belonging to the genre to which the content belongs, based on times of reproducing, date and time of reproducing, date and time of recording, or-date and time of making.

10. A content reproduction method, in which a content is reproduced, comprising:
a thumbnail-icon display step of displaying a thumbnail of a content and an icon about a genre of the content simultaneously; and
a screen display step of displaying a screen correspond to the thumbnail or the icon selected when the thumbnail or the icon is selected.

11. A program embodied on a non-transitory computer-readable medium, the program causing a computer to execute steps of a content reproduction method, the content reproduction method, in which a content is reproduced, comprising:
a thumbnail-icon display step of displaying a thumbnail of a content and an icon about a genre of the content simultaneously; and
a screen display step of displaying a screen correspond to the thumbnail or the icon selected when the thumbnail or the icon is selected.
